(19) United States
(12) Patent Application Publication
(10) Pub. No.: US 2015/0100544 A1
(43) Pub. Date: Apr. 9, 2015

(54) METHODS AND SYSTEMS FOR DETERMINING HIERARCHICAL COMMUNITY DECOMPOSITION

(71) Applicant: ALCATEL-LUCENT USA INC., Murray Hill, NJ (US)

(72) Inventors: William S. KENNEDY, Summit, NJ (US); Yihao ZHANG, Chatham, NJ (US); Gordon WILFONG, Florham Park, NJ (US); Jamie H. MORGENSTERN, Pittsburgh, PA (US)

(73) Assignee: ALCATEL-LUCENT USA INC., Murray Hill, NJ (US)

(21) Appl. No.: 14/046,149

(22) Filed: Oct. 4, 2013

(51) Int. Cl. G06F 17/30

(52) U.S. Cl. CPC G06F 17/30589
USPC 707/609; 707/737

(57) ABSTRACT

In one example embodiment, a method of determining a hierarchical community decomposition of a plurality of nodes includes determining one or more subsets of the plurality of nodes at at least one level of the hierarchical community decomposition, the determined one or more subsets being non-detachable and non-linkable. The method further includes forming the at least one level of the hierarchical community decomposition based on the determined one or more subsets.

### BACKGROUND

Demand for accessible information, due in part to the rapid increase in online interactions, has led many research, business and marketing communities to examine large social data sets in which information is connected in a graphical manner. Mining the structural properties of these data sets may reveal a wealth of information about how entities, such as, people, societies, objects and ideas, interact.

A key problem is the determination of communities, that is, subsets of these entities that are in some sense more related to each other than the remaining entities. Intuitively, it is expected that these communities are nested into a hierarchical structure, for example, the community of smartphone users can be further decomposed into communities based on manufacturer of users' smartphones. This finer gain approach to modeling community structure gives further insight into how communities are established, change, and interact in the greater context of these large social data sets.

Some of the existing approaches are designed to scale community detection algorithms to cope with large-scale networks. Many of these proposed techniques leverage local optimizations or local greedy decisions to iteratively find the communities. However, using such techniques risks missing the global structure of the network.

### SUMMARY

Some example embodiments relate to methods, apparatuses and/or computer program products to provide a hierarchical community decomposition of a set of data/nodes.

In one example embodiment, a method of determining a hierarchical community decomposition of a plurality of nodes includes determining one or more subsets of the plurality of nodes at at least one level of the hierarchical community decomposition, the determined one or more subsets being non-detachable and non-linkable. The method further includes forming the at least one level of the hierarchical community decomposition based on the determined one or more subsets.

In yet another example embodiment, the determining the one or more subsets includes forming an auxiliary structure, partitioning the auxiliary structure into at least two subsets and determining whether to detach at least one group formed based on the at least two subsets.

In yet another example embodiment, the determining whether to detach the at least one group includes determining whether any two or more of the at least two subsets are linkable with respect to a union of the at least two subsets, forming the at least one group from two or more subsets of the at least two subsets based on the determination that the two or more of the at least two subsets are linkable and detaching the at least one formed group.

In yet another example embodiment, the detaching the at least one formed group includes partitioning the at least one formed group into two or more smaller subsets and determining whether any of the two or more smaller subsets is detachable with respect to the at least one formed group. The detaching the at least one formed group further includes splitting the at least one formed group into a first further subset and a second further subset based on the determination that one or more of the smaller subsets is detachable with respect to the at least one formed group, the first further subset corresponding to one of the two or more smaller subsets that is detachable and the second further subset corresponding to remaining nodes within the at least one formed group.

In yet another example embodiment, the detaching the at least one formed group further includes upon more than one group being formed, determining whether each of the formed groups has been partitioned into two or more smaller subsets and repeating the partitioning the at least one formed group, determining whether any of the two or more smaller subsets is detachable and the splitting based on the determination that at least one formed group has not been partitioned into two or more smaller subsets.

In yet another example embodiment, upon determining that no two or more of the at least two subsets are linkable, the determining the one or more subsets further includes determining a number of times the formed auxiliary set has been partitioned. The determining the one or more subsets further includes repeating the partitioning and determining whether any two or more of the at least two or more subsets are linkable until the number of times is greater than a threshold.

In yet another example embodiment, upon determining that no two or more of the smaller subsets is detachable with respect to the at least one formed group, the detaching the at least one formed group further includes determining a number of times the at least one formed group has been partitioned. The detaching the at least one formed group further includes repeating the partitioning the at least one formed group into two or more smaller subsets, determining whether any of the two or more smaller subsets is detachable with respect to the at least one formed group and the splitting until the number of times is greater than a threshold.

In yet another example embodiment, the method includes receiving input data associated with the plurality of nodes as well as levels of connectivity between the plurality of nodes.

In yet another example embodiment, the method includes forming the first layer of the hierarchical community decomposition as a union of the plurality of nodes.

In yet another example embodiment, the method includes updating the hierarchical community decomposition based on the determined one or more subsets at the at least one level of the hierarchical community decomposition.

In yet another example embodiment, the method includes, upon determining the one or more subsets at the at least one level of the hierarchical community decomposition, determining whether any of the determined one or more subsets has more than one node and repeating the determining one or more subsets and updating the hierarchical community decomposition based on the determination that at least one of the determined one or more subsets has more than one node.

In yet another example embodiment, the method includes outputting the hierarchical community decomposition and analyzing the structure and the interaction among the plurality of nodes based on the outputted hierarchical community decomposition.

In one example embodiment, a device for determining a hierarchical community decomposition of a plurality of nodes includes a processor configured to determine one or more subsets of the plurality of nodes at at least one level of the hierarchical community decomposition, the determined one or more subsets being non-detachable and non-linkable. The processor is further configured to form the at least one level of the hierarchical community decomposition based on the determined one or more subsets.

In yet another example embodiment, the processor is configured to determine the one or more subsets by forming an auxiliary structure, partitioning the auxiliary structure into at least two subsets and determining whether to detach at least one group formed based on the at least two subsets.

In yet another example embodiment, the processor is configured to determine whether to detach the at least one group by determining whether any two or more of the at least two subsets are linkable with respect to a union of the at least two subsets, forming the at least one group from two or more subsets of the at least two subsets based on the determination that the two or more subsets are linkable and detaching the at least one formed group.

In yet another example embodiment, the processor is configured to detach the at least one formed group by partitioning the at least one formed group into two or more smaller subsets and determining whether any of the two or more smaller subsets is detachable with respect to the at least one formed group. The processor is further configured to detach the at least one formed group by splitting the at least one formed group into a first further subset and a second further subset based on the determination that one or more of the smaller subsets is detachable with respect to the at least one formed group, the first further subset corresponding to one of the two or more smaller subsets that is detachable and the second further subset corresponding to remaining nodes within the at least one formed group.

In yet another example embodiment, the processor is further configured to detach the at least one formed group by, upon more than one group being formed, determining whether each of the formed groups has been partitioned into two or more smaller subsets and repeating the partitioning the at least one formed group, determining whether any of the two or more smaller subsets is detachable and the splitting based on the determination that at least one formed group has not been partitioned into two or more smaller subsets.

In yet another example embodiment, upon the processor determining that no two or more of the at least two or more subsets are linkable, the processor is configured to determine the one or more subsets by determining a number of times the formed auxiliary set has been partitioned, repeating the partitioning and determining whether any two or more of the at least two subsets are linkable until the number of times is greater than a threshold.

In yet another example embodiment, upon the processor determining that no two or more of the smaller subsets is detachable with respect to the at least one formed group, the processor is configured to detach the at least one formed group by determining a number of times the formed group has been partitioned and repeating the partitioning the at least one formed group into two or more smaller subsets, determining whether any of the two or more smaller subsets is detachable with respect to the formed group and the splitting until the number of times is greater than a threshold.

In yet another example embodiment, the processor is further configured to receive input data associated with the plurality of nodes as well as levels of connectivity between the plurality of nodes.

In yet another example embodiment, the processor is further configured to form the first layer of the hierarchical community decomposition as a union of the plurality of nodes.

In yet another example embodiment, the processor is further configured to update the hierarchical community decomposition based on the determined one or more subsets at the at least one level of the hierarchical community decomposition.

In yet another example embodiment, the processor is further configured to, upon determining the one or more subsets at the at least one level of the hierarchical community decomposition, determine whether any of the determined one or more subsets has more than one node and repeat the determining one or more subsets and updating the hierarchical community decomposition based on the determination that at least one of the determined one or more subsets has more than one node.

In yet another example embodiment, the processor is further configured to output the hierarchical community decomposition and analyze the structure and the interaction among the plurality of nodes based on the outputted hierarchical community decomposition.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 depicts a system for implementing a hierarchical community decomposition of a given plurality of nodes, according to an example embodiment;

FIG. 2 describes a method for forming a hierarchical community decomposition of the given plurality of nodes, according to an example embodiment;

FIG. 3 describes a method for determining inter-connectivity between subsets of the given plurality of nodes, according to an example embodiment; and

FIG. 4 describes a method for determining intra-connectivity of nodes within a given subset of the given plurality of nodes, according to an example embodiment.

### DETAILED DESCRIPTION OF EXAMPLE EMBODIMENTS

Various embodiments will now be described more fully with reference to the accompanying drawings. Like elements on the drawings are labeled by like reference numerals.

Detailed illustrative embodiments are disclosed herein. However, specific structural and functional details disclosed herein are merely representative for purposes of describing example embodiments. This disclosure may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged, and certain operations may be omitted or added to the process. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory content. Information, arguments, parameters, data, etc. may be passed, forwarded, or transmitted via any suitable means including memory sharing, message passing, token passing, network transmission, etc.

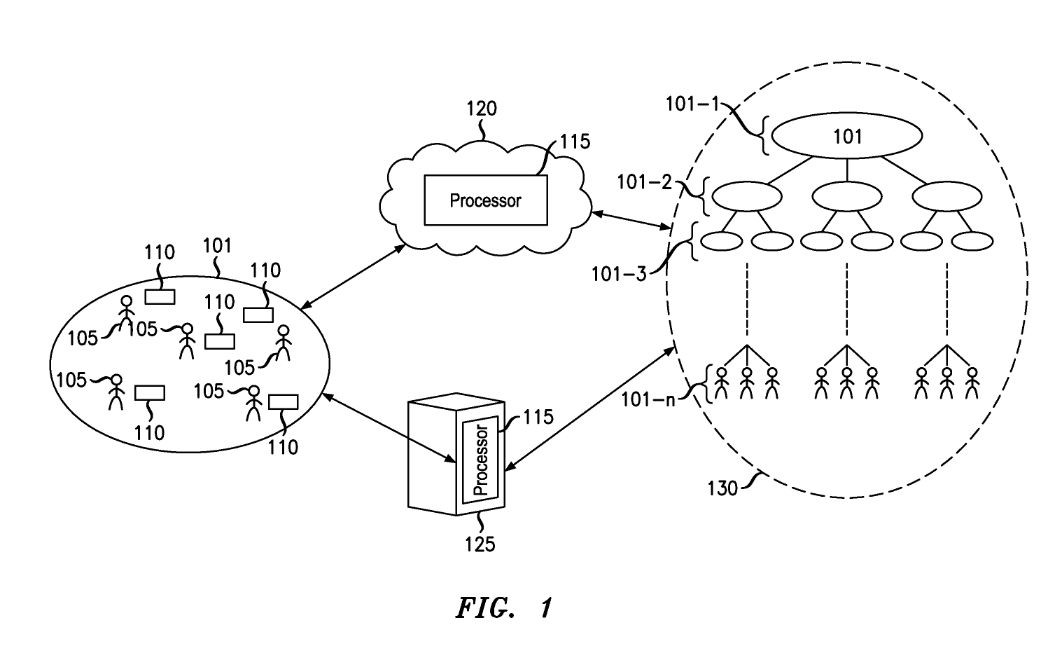

FIG. 1 depicts a system for implementing a hierarchical community decomposition of a given plurality of nodes, according to an example embodiment. FIG. 1 depicts a data set of a plurality of nodes 101, the information associated with which may be inputted into a computing algorithm running on one or more processors such as processor 115. The plurality of nodes 101 may include nodes 105 and 110. The nodes 101 may represent entities such as, for example, people, users of a service, users of a device, etc., the relationship among such entities may be presented in a hierarchical form. The nodes 110 may represent other entities such as, for example, devices, objects, etc., the relationship among such other entities may also be presented in a hierarchical form. The device nodes 110 may or may not be associated with the user nodes 105. For example, the plurality of nodes 105 may represent users of a social networking website, users of a wireless service provider, users of a particular type of device, etc. Even broader, the set of data 101 may represent users of multiple social networking websites, users of multiple wireless service providers, etc. The device nodes 110 may represent electronic devices of a certain type (e.g., consumer electronics, computers, mobile phones, etc.), which may be related based on, for example, their utility, type, model, manufacturer, etc.

A reader appreciates that the nodes within the set 101 are not limited to user nodes 105 and/or device nodes 110 but may in practice represent any objects, devices, etc., the relationship among which may be presented in a hierarchical form.

In addition to the plurality of nodes 101, a set of connections between the nodes, which may convey how the entities represented by the user nodes 105 and/or device nodes 110 interact or are related to one another, may also be received by the processor 115. In one example embodiment, the connections may be represented as a set of weights (e.g., wᵢⱼ), where the greater the value of w is, the stronger is the connection between nodes i and j (e.g., two nodes 105 and/or 110).

The computing algorithm may be a software package, executed by the processor 115. The processor 115 may be included on a cloud computing infrastructure 120 and/or a desktop 125. In one example embodiment, the processor 115 located on the cloud computing infrastructure 120 and the desktop 125 may not be the same. In one example embodiment, processor 115 may execute the computing algorithm on both the cloud computing infrastructure 120 and the desktop 125 simultaneously and the results may be compared at the end. While shown as stationary hardware, desktop 125 may be any one of, but not limited to, a personal computer, a server, a laptop, a mobile device, etc.

The processor 115, according to the method, which will be further described below, may be configured to output a hierarchical community decomposition (HCD) 130 for the data set of the plurality of nodes 101. HCD 130 may also be referred to as hierarchical decomposition (HD) of the data set of the plurality of nodes 101. HCD 130 may comprise of levels 101-1 to 101-n, where the number of levels n may depend on the complexity and/or the number of nodes within the input plurality of nodes 101. In one example embodiment, level 101-n corresponds to the most detailed level of the HCD 130 (e.g., individual user nodes 105 and/or device nodes 110 of the plurality of Nodes 101), while level 101-1 may refer to the most general level of the HCD 130. In one example embodiment, a community may refer to a subset of the plurality of nodes 101, which during a decomposition of the plurality of nodes 101, may be formed or output by the processor 115. Hereinafter, the terms community and subset may be used interchangeably.

The community structure of many networks and/or data sets of nodes is naturally hierarchical. Communities can be iteratively divided into smaller communities. In forming these communities, one challenge is to define a “good community” of nodes or a “good subset” of nodes. Many definitions for such a “good community” of nodes have been developed. For example, one such definition states that a “good community” of nodes is likely to have a small diameter (i.e. the shortest path distance between any node pairs is small or within a desired (or, alternatively predetermined) value). Another such definition provides that a “good community” of nodes is likely to be sufficiently dense, where the density reflects the nodes within a sub-graph (i.e., nodes of a “good community” interact more with each other than other nodes outside the sub-graph).

One method of finding such “good communities” of nodes relies on the theory of graph cuts. This method states that given a subset S of the plurality of nodes, a cut is a set of edges (e.g., set of weights between the nodes, described above) each of which has one endpoint inside S and one outside S. The method further defines a conductance as a ratio of the cut size to the number of edges inside the cut. Accordingly, the lower the conductance, the closer is the cut to a “good community” of nodes.

Furthermore, one HCD method applies, for example, the above method based on the theory of graph cuts, to the original data set of plurality of nodes and forms one level of hierarchy including new communities/subsets of the data set of the plurality of nodes. Thereafter, the HCD method iteratively applies the said method to each created subset to further extend the hierarchy. Such method focuses on what may be referred to as local optimization of subsets and may therefore miss the global structure of the nodes.

The example embodiments set forth herein may further improve the definition of “good communities” of nodes and create a HCD of a set of data of a plurality of nodes, which captures both local and global structures of the plurality of nodes. In doing so, and as will be described in greater detail below, systems and methods are provided for the creation of communities/subsets of nodes that satisfy three conditions. First, at each hierarchical level, a single node (e.g., data representing a single node) is included in only one subset. Second, at each hierarchical level, each subset/community is better intra-connected than interconnected (i.e., the connection among nodes within each subset is considered as being relatively stronger or better than an external connection between any of the nodes within each subset and any other nodes within other subsets at the same hierarchical level). The second condition may also be referred to as the detachability condition. The third condition is that no two or more subsets of nodes are better inter-connected than any other two or more subsets of nodes at the same hierarchical level (i.e., the connection between any two or more subsets of nodes at a given hierarchical level is not relatively better/stronger that the connection between any other two or more subsets of nodes at the given hierarchical level). The third condition may also be referred to as the linkability condition.

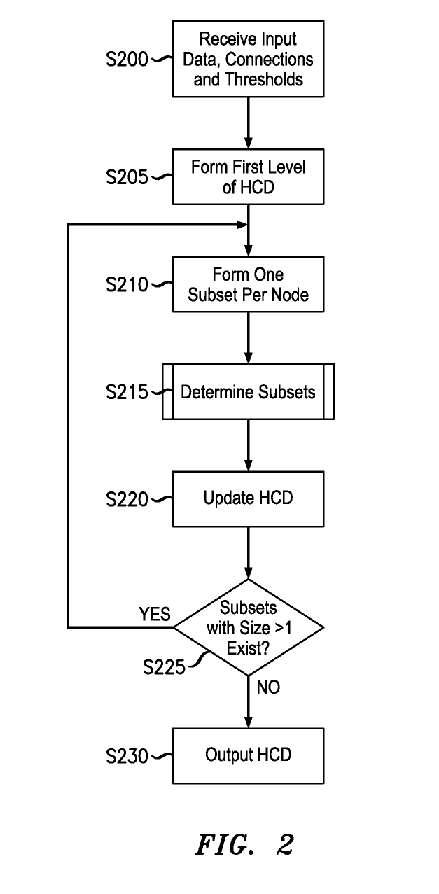

FIG. 2 describes a method for forming a hierarchical community decomposition of the given set of data of the plurality of nodes 101 based on the conditions above, according to an example embodiment. Referring to FIG. 1 and FIG. 2, at S200, the processor 115, running on the cloud computing infrastructure 120 and/or desktop 125, may receive input data associated with a plurality of nodes 101 and connections between such nodes (e.g., set of weights). The processor 115 may further receive a plurality of threshold values, which will be further described below. Let such input data associated with the plurality of nodes 101 and the set of connections (e.g., weights) associated with the nodes be represented by G=(V, E), where V is the input data associated with the plurality of nodes and E is the set of weights. E may also be referred to as edges between the nodes. The weights may indicate how nodes may be related and or connected to one another. For example, input data representing a set of users of a social networking website may be received by the processor 115, where 5 users may be represented as members of a particular group on the social networking website (e.g., the 5 users may be have become fans of a profile of a particular artist on the social networking website). While being users of the social networking website is one type of connection, membership or being fans of the particular artist may be another connection, which is also received by the processor 115.

At S205, the processor 115 may form one level of the HCD 130 (e.g., the most general level of the HCD 130, level 101-1 shown in FIG. 1. At S210, the processor 115 may form one subset per node for all of the plurality of nodes received at S200). After the initial step and as will be further described below, at S210, the processor 115 may form one subset per node for the nodes corresponding to each subset with a size greater than 1.

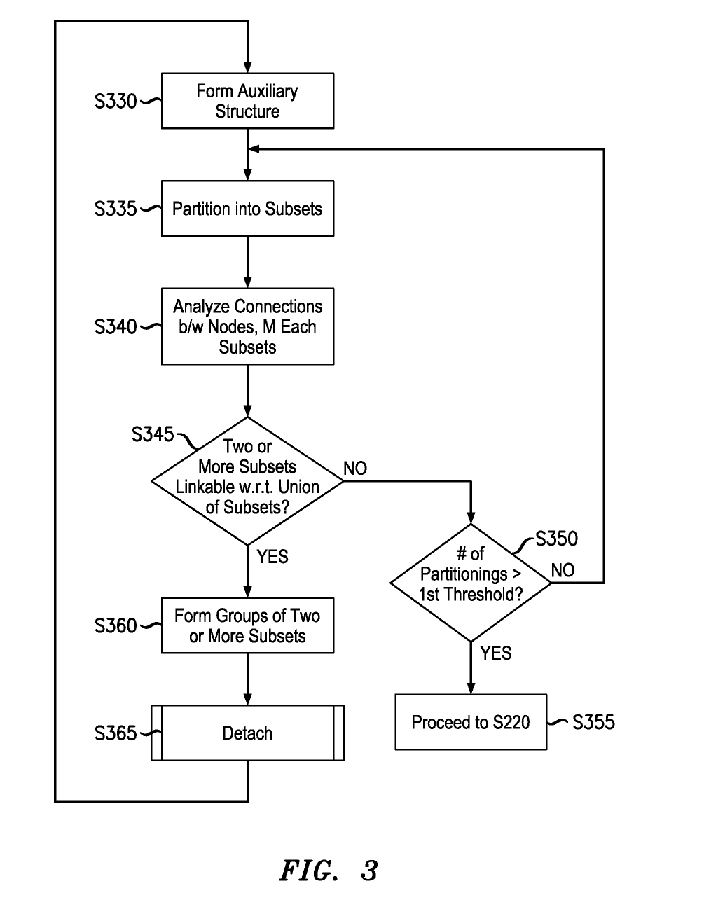

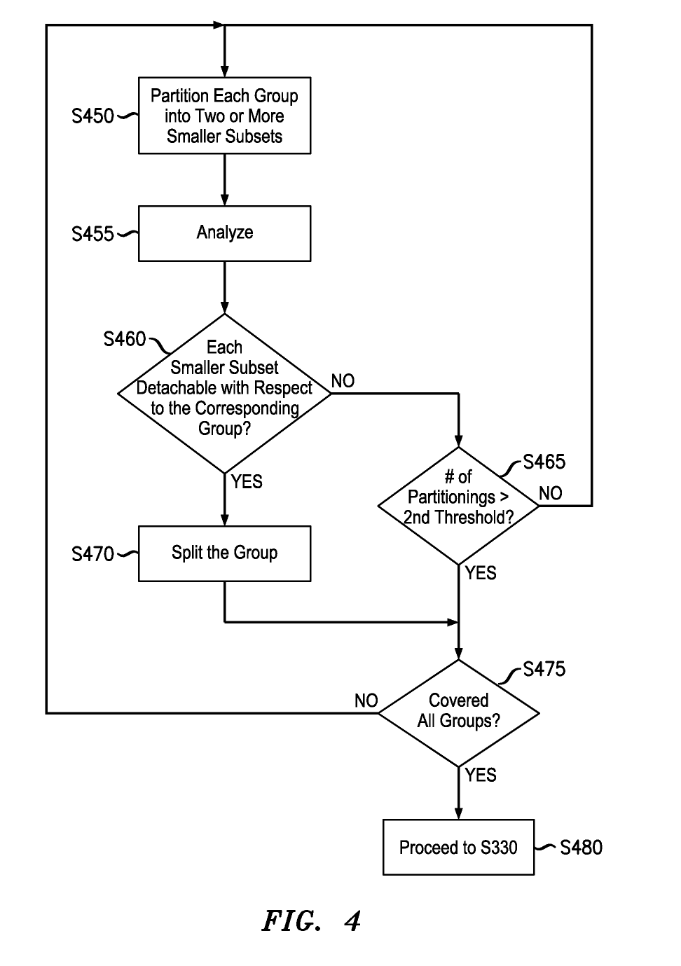

At S215, the processor 115 may determine subsets of the plurality of nodes 101 and analyze the internal and external links between subsets and nodes within subsets so as to ensure that the above recited three conditions are satisfied. Such analysis by the processor 115 will be further described with reference to FIG. 3 and FIG. 4.

FIG. 3 describes a method for determining inter-connectivity between subsets of the given plurality of nodes, according to an example embodiment. Referring to FIG. 2 and FIG. 3, at S330 the processor 115 may form an auxiliary structure. In one example embodiment, the auxiliary structure may represent a candidate subset of the set of nodes, the non-linkability and/or non-detachability of which will be assessed by the processor 115, as will be described below. In other words, the auxiliary structure represents an initial assessment of a “good community” of nodes, described above. Thereafter, by implementing the process described below with reference to FIGS. 3-4, the processor 115 determines whether the auxiliary structure does in fact represent a “good community” of nodes or whether it should be partitioned into alternative subsets so as to obtain non-linkable and non-detachable subsets.

The candidate subset of the data set of nodes forming the auxiliary structure may initially be the same as nodes included in the level of the hierarchical community decomposition formed at S205. Thereafter, the auxiliary set of nodes may include further smaller determined subsets of nodes created, at each level of the hierarchical community decomposition, which are going to be analyzed in order to determine the subsequent level of the HCD.

At S335, the processor 115 may further partition the instant auxiliary structure into subsets (e.g., at least two subsets). The processor 115 may do so by analyzing the plurality of nodes 101 and the weights received at S200. The processor 115 may partition a set of nodes of the auxiliary data structure (e.g., the initial set of nodes V and/or subsequent subsets V′, as will be described below) into subsets using a method which may be referred to as SPECTRALCUT. The processor 115 may alternatively partition the set of nodes (e.g., the initial set of nodes V and/or subsequent subsets V′) using any known method. Accordingly, one advantage of the example embodiments described herein may be the compatibility of the underlying method with any presently known or to be developed method for partitioning the set of nodes.

The processor 115 via SPECTRALCUT, may take as input a set of nodes V′ of the auxiliary structure, which initially may be the same as V, and output two subsets of the plurality of nodes V′, which may be referred to as P₁ and P₂. After the initial step and during the determining of non-linkable and non-detachable subsets, as will be described below, V′ may represent one or more subsets of the set of node V.

The processor 115 via SPECTRALCUT may take, as an input, V′ and create L, which may be referred to as a Laplacian of V′. The processor 115 via SPECTRALCUT then computes a set (u₁, u₂), which may be equivalent to the smallest two eigenvectors of L. The processor 115 via SPECTRALCUT may then create (C₁, C₂), which is a 2-means clustering of the columns of (u₁, u₂). Thereafter, The processor 115 via SPECTRALCUT partitions V′ into (P₁, P₂) based on (C₁, C₂). In one example embodiment, after an initial application of SPECTRALCUT, V may be written as V=V′=P={P₁ U P₂}.

Once the processor 115 partitions the auxiliary set into subsets (e.g., P₁, P₂, . . . Pₖ), at S340, the processor 115 may further analyze the connections between the partitioned subsets.

At S345, the processor 115, upon analyzing the edges (e.g., connections) between the two or more subsets Pᵢs (i belonging to {1, 2, . . . k}) and/or nodes within the two or more subsets, may determine whether any of the two or more subsets are linkable with respect to a union of the subsets created as a result of the partitioning at S335.

In one example embodiment, the processor 115 may be configured with a threshold value, which may also be referred to as a linkability threshold, 6. The linkability threshold may be equal to or greater than one.

In one example embodiment, the linkability of subsets, at S345, is determined as follows. Let Cap (X,Y)=Σw_{xy}, where x belongs to X and y belong to Y and X and Y be subsets of V. Cap (X,Y) may be considered as the total connections or capacity between X and Y. Furthermore, let the linkability threshold 6 be greater than or equal to 1, {P₁, P₂, . . . Pₖ} be a partition of V′ and R be a union of Pᵢ, where i belongs to I which is a subset of {1, 2, . . . k}. Then R is linkable with respect to V′ if (1) size of R is less than or equal to half the size of V′ and (2)

$$\frac{\sum i , j ∈ I , i \neq j cap ( Pi , Pj )}{\sum i ∈ I , j \neq I cap ( Pi , Pj )} > δ .$$

By implementing S345, the processor 115 may ensure the third condition described above is satisfied such that no set of communities/subsets at a given level of hierarchical community decomposition is better inter-connected. With reference to the example embodiment provided at the end of the preceding paragraph, carrying out S340 may partially contribute to answering the question of whether individual communities/subsets (e.g., P₁, P₂, and P₃) constitute “good communities” of nodes or in the alternative, whether two or more of Pᵢs should together form a community of nodes. For example, whether {P₁U P₂} and P₃ form a better decomposition of P at a given level of the hierarchical community decomposition.

If the processor 115 determines at S345 that no two or more of the subsets created as a result of the partitioning at S335 are linkable, then at S350, the processor 115 may determine the number of times the auxiliary structure has been partitioned. In one example embodiment, if the number of times the auxiliary structure has been partitioned is less than a first threshold, the processor 115 may repeat S335-S345 for several times until the number of times the auxiliary structure has been partitioned is greater than the first threshold. The first threshold may be set initially by a system administrator or may alternatively be determined based on empirical studies, etc.

The repeating may take place even though the processor 115 may have determined that none of subsets created as a result of the partitioning at S335 are linkable. The processor 115 may do so, because SPECTRALCUT, or any other method used as a replacement for SPECTRALCUT, may be randomized and only a heuristic for finding non-linkable subsets.

However, if at S350 the processor determines that the number of times the auxiliary structure has been partitioned is greater than the first threshold, then the processor 115, at S355, returns the subsets created as a result of the partitioning at S335, as determined subsets at S215 in FIG. 2. Thereafter, the process may return to S220 of FIG. 2, which will be further described below.

If, at S345, the processor 115 determines that any two or more of the subsets are linkable with respect to the union of the subsets created as a result of the partitioning at S335, the processor 115, at S360, may form groups of two or more subsets, where linkable subsets may form a larger subset. For example R, as described above may be one such formed group. Thereafter, at S365, the processor may detach the formed group, which will be further described with reference to FIG. 4.

Accordingly, the process described with reference to FIG. 3 may result in non-linkable subsets at any given level of the HD 130.

FIG. 4 describes a method for determining intra-connectivity of nodes within a given subset of the given plurality of nodes, according to an example embodiment. In one example embodiment, by performing S450-S480, as shown in FIG. 4 and as will be described below, the processor 115 may implement the detaching, at S365 of FIG. 3.

At S450, the processor 115 may partition the formed group into two or more smaller subsets. For example, the processor 115 may partition R into two or more smaller subsets using, for example, the SPECTRALCUT method described above. The processor 115 may alternatively partition the set of nodes V using any known method. Accordingly, one advantage of the example embodiments described herein may be the compatibility of the underlying method with any presently known or to be developed method for partitioning the groups.

At S455, the processor may analyze each of the two or more subsets and based on the analyzing may determine, at S460, whether any of the two or more subsets are detachable with respect to the corresponding group.

In one example embodiment, at S460, the processor may determine the detachability of any of the two or more smaller subsets as follows. Let U be one such smaller subset created at S450. Furthermore, let V′ be a subset of V and U be a subset of V′. Then U is detachable with respect to R if (1) the size of U is less than or equal to half the size of V′ and (2)

$$\frac{cap ( U , V \backslash U )}{cap ( U , {V}^{′} \backslash U )} \geq λ .$$

where λ may indicate a detachability threshold, which is greater than or equal to 1. The processor 115 may be configured with an appropriate detachability threshold.

This determination by the processor 115 at S460 may ensure the second condition that at each level of hierarchical community decomposition, each subset/community is better internally connected than externally connected to another community/subset at the same hierarchical level.

If the processor 115 determines at S460 that no two or more of the smaller subsets created as a result of the partitioning at S450 are detachable with respect to the group, then at S465, the processor 115 may determine the number of times the group has been partitioned. In one example embodiment, if the number of times the group has been partitioned is less than a second threshold, the processor 115 may repeat S450 to S460 for several times until the number of times of partitioning is greater than the second threshold. The second threshold may be set initially by a system administrator or may alternatively be determined based on empirical studies, etc. The first and the second thresholds may be the same or may be set at different values.

The repeating may take place even though the processor 115 may have determined that none of smaller subsets are detachable. The processor 115 may do so, because SPECTRALCUT, or any other method used as a replacement for SPECTRALCUT, may be randomized and only a heuristic for finding non-detachable subsets.

However, if at S465 the processor 115 determines that the number of times the group has been partitioned is greater than the second threshold, then the processor 115, at S475, may determine whether each of the groups formed at S360 has been covered (e.g., portioned into two or more smaller subsets). If the processor 115 determines that all the groups have been covered, then the processor may return to S330 of FIG. 3.

If however, the processor 115 determines that at least one group formed at S360 remains, which has not been covered, then the process may return to S450 and the processor 115 may repeat the process of S450-S470 described above with respect to the groups that have not been covered.

However, if at S460, the processor 115 determines that one of the two or more smaller subsets is detachable with respect to the corresponding group, then at S470, the processor 115 may split the one of the two or more smaller subsets that is detachable. For example, with reference to the example described above, the processor 115 may split R into U and R-U, if the processor 115 determines at S460 that U is detachable with respect to R.

Thereafter, the processor may proceed to S475 and S475 and S480 may be implemented as described above. Accordingly, the process described with reference to FIG. 4 may result in non-detachable subsets at any given level of the HD 130.

Referring back to FIG. 2, once non-linkable and non-detachable subsets, based on the process described in FIGS. 3-4 have been determined, the processor 115 may update HCD at S220. For example, at the end of each iteration of the processor described in FIGS. 3-4, the processor 115 may update the corresponding level of the hierarchical community decomposition 130, shown in FIG. 1.

In another example embodiment, instead of dynamically updating the HCD 130, the processor 115 may save the subsets, determined during each iteration of the process described above with reference to FIGS. 3-4 and then at the end form the HCD 130.

At S225, the processor 115 determines whether any of the determined subsets, which having been formed as a result of the processes described with respect to FIG. 3 and FIG. 4 and now satisfy the three conditions described above, have a size greater than 1. In other words, the processor 115 at S225 determines whether each of the determined subsets include more than one node.

If at S225, the processor 115 determines that at least one of the determined subsets include more than 1 node, then the process reverts back to S210, where the processor 115 creates one subset per node for the nodes forming the at least one of the determined subsets with more than 1 node. Thereafter, each of the determined subsets with a size greater than 1 undergo the process described with reference to FIGS. 3 and 4 until no subset with more than one node is left at the most detailed level 101-n of the HCD 130, as shown in FIG. 1.

In one example embodiment, once the processor 115 determines, at S225, that all the created subsets at the most detailed level 101-n have a size of 1, the processor 115 at S230 outputs the HCD 130 of the plurality of nodes V. The processor 115 may output the HCD 130 to an end user requesting the HCD 130. The processor 115 may output the HCD 130 by, for example, displaying the HCD 130 in a graphical representation on a display (e.g., a computer monitor, a display of a mobile device, etc.). The processor 115 may alternatively store the HCD 130 in one or more computer readable data structures or database (e.g., for subsequent access and/or use).

As discussed above, the end user may use the HCD 130 for purposes including, but not limited to, marketing, targeted advertising, etc. In one example embodiment, the end user, via the processor 115 may analyze the outputted HCD 130 in order to study the structure of the plurality of nodes and/or the interaction among the plurality of nodes. Alternatively, the end user may use a separate computer/processor to analyze the outputted HCD 130.

Variations of the example embodiments are not to be regarded as a departure from the spirit and scope of the example embodiments, and all such variations as would be apparent to one skilled in the art are intended to be included within the scope of this disclosure.

What is claimed:

1. A method of determining a hierarchical community decomposition of a plurality of nodes, the method comprising:
determining one or more subsets of the plurality of nodes at at least one level of the hierarchical community decomposition, the determined one or more subsets being non-detachable and non-linkable; and
forming the at least one level of the hierarchical community decomposition based on the determined one or more subsets.

2. The method of claim 1, wherein the determining the one or more subsets comprises:
forming an auxiliary structure;
partitioning the auxiliary structure into at least two subsets; and
determining whether to detach at least one group formed based on the at least two subsets.

3. The method of claim 2, wherein the determining whether to detach the at least one group includes:
determining whether any two or more of the at least two subsets are linkable with respect to a union of the at least two subsets;
forming the at least one group from two or more of the at least two subsets based on the determination that the two or more of the at least two subsets are linkable; and
detaching the at least one formed group.

4. The method of claim 3, wherein the detaching the at least one formed group comprises:
partitioning the at least one formed group into two or more smaller subsets;
determining whether any of the two or more smaller subsets is detachable with respect to the at least one formed group; and
splitting the at least one formed group into at least a first further subset and a second further subset based on the determination that one or more of the two or more smaller subsets is detachable with respect to the at least one formed group, the first further subset corresponding to one of the two or more smaller subsets that is detachable and the second further subset corresponding to remaining nodes within the at least one formed group.

5. The method of claim 4, wherein the detaching the at least one formed group further comprises:
upon more than one group being formed, determining whether each of the formed groups has been partitioned into two or more smaller subsets;
repeating the partitioning the at least one formed group, determining whether any of the two or more smaller subsets is detachable and the splitting based on the determination that at least one formed group has not been partitioned into two or more smaller subsets.

6. The method of claim 3, wherein upon determining that no two or more of the at least two subsets are linkable, the determining one or more subsets further comprises:
determining a number of times the formed auxiliary set has been partitioned; and
repeating the partitioning and the determining whether any two or more of the at least two subsets are linkable until the number of times is greater than a threshold.

7. The method of claim 4, wherein upon determining that no two or more of the smaller subsets is detachable with respect to the at least one formed group, the detaching the at least one formed group further comprises:
determining a number of times the at least one formed group has been partitioned; and
repeating the partitioning the at least one formed group into two or more smaller subsets, determining whether any of the two or more smaller subsets is detachable with respect to the at least one formed group and the splitting until the number of times is greater than a threshold.

8. The method of claim 1, further comprising:
receiving input data associated with the plurality of nodes as well as levels of connectivity between the plurality of nodes.

9. The method of claim 1, further comprising:
forming the first layer of the hierarchical community decomposition as a union of the plurality of nodes.

10. The method of claim 1, further comprising:
updating the hierarchical community decomposition based on the determined one or more subsets at the at least one level of the hierarchical community decomposition.

11. The method of claim 10, further comprising:
upon determining the one or more subsets at the at least one level of the hierarchical community decomposition, determining whether any of the determined one or more subsets has more than one node; and
repeating the determining one or more subsets and updating the hierarchical community decomposition based on the determination that at least one of the determined one or more subsets has more than one node.

12. The method of claim 1, further comprising:
outputting the hierarchical community decomposition; and
analyzing the structure and the interaction among the plurality of nodes based on the outputted hierarchical community decomposition.

13. A device for determining a hierarchical community decomposition of a plurality of nodes, comprising:
a processor configured to,
determine one or more subsets of the plurality of nodes at at least one level of the hierarchical community decomposition, the determined one or more subsets being non-detachable and non-linkable; and
form the at least one level of the hierarchical community decomposition based on the determined one or more subsets.

14. The device of claim 13, wherein the processor is configured to determine the one or more subsets by:
forming an auxiliary structure;
partitioning the auxiliary structure into at least two subsets; and
determining whether to detach at least one group formed based on the at least two subset.

15. The device of claim 14, wherein the processor is configured to determine whether to detach the at least one group by:
determining whether any two or more of the at least two subsets are linkable with respect to a union of the at least two subsets;
forming the at least one group from the two or more of the at least two subsets based on the determination that the two or more of the at least two subsets are linkable; and
detaching the at least one formed group.

16. The device of claim 15, wherein the processor is configured to detach the at least one formed group by:
partitioning the at least one formed group into two or more smaller subsets;
determining whether any of the two or more smaller subsets is detachable with respect to the at least one formed group; and
splitting the at least one formed group into a first further subset and a second further subset based on the determination that one or more of the two or more smaller subsets is detachable with respect to the at least one formed group, the first further subset corresponding to one of the two or more smaller subsets that is detachable and the second further subset corresponding to remaining nodes within the at least one formed group.

17. The device of claim 16, wherein the processor is further configured to detach the at least one formed group by:
upon more than one group being formed, determining whether each of the formed groups has been partitioned into two or more smaller subsets;
repeating the partitioning the at least one formed group, determining whether any of the two or more smaller subsets is detachable and the splitting based on the determination that at least one formed group has not been partitioned into two or more smaller subsets.

18. The device of claim 15, wherein upon the processor determining that no two or more of the at least two subsets are linkable, the processor is configured to determine the one or more subsets by:
determining a number of times the formed auxiliary set has been partitioned; and
repeating the partitioning and the determining whether any two or more of the at least two subsets are linkable until the number of times is greater than a threshold.

19. The device of claim 16, wherein upon the processor determining that no two or more of the smaller subsets is detachable with respect to the at least one formed group, the processor is configured to detach the at least one formed group by:
determining a number of times the formed group has been partitioned; and
repeating the partitioning the at least one formed group into two or more smaller subsets, determining whether any of the two or more smaller subsets is detachable with respect to the formed group and the splitting until the number of times is greater than a threshold.

20. The device of claim 13, wherein the processor is further configured to receive input data associated with the plurality of nodes as well as levels of connectivity between the plurality of nodes.

21. The device of claim 13, wherein the processor is further configured to form the first layer of the hierarchical community decomposition as a union of the plurality of nodes.

22. The device of claim 13, wherein the processor is further configured to update the hierarchical community decomposition based on the determined one or more subsets at the at least one level of the hierarchical community decomposition.

23. The device of claim 22, wherein the processor is further configured to,
upon determining the one or more subsets at the at least one level of the hierarchical community decomposition, determine whether any of the determined one or more subsets has more than one node; and
repeat the determining one or more subsets and updating the hierarchical community decomposition based on the determination that at least one of the determined one or more subsets has more than one node.

24. The device of claim 13, wherein the processor is further configured to,
output the hierarchical community decomposition; and
analyze the interaction among the plurality of nodes based on the outputted hierarchical community decomposition.
